(19) United States
(12) Patent Application Publication
(10) Pub. No.: US 2017/0151635 A1
(43) Pub. Date: Jun. 1, 2017

(54) SMALL DIAMETER TRIANGLE SEAM CONTROL WIRE AND PREFORM

(71) Applicant: LUCAS-MILHAUPT, INC., Cudahy, WI (US)

(72) Inventor: Dean W. Kick, Oak Creek, WI (US)

(21) Appl. No.: 15/119,334

(22) PCT Filed: Jun. 29, 2016
(86) PCT No.: PCT/US16/40073

§ 371 Date: Aug. 16, 2016

Related U.S. Application Data
(63) Continuation of application No. 29/513,685, filed on Jan. 5, 2015, now Pat. No. D764030.
Application No. 29/513,685 is a continuation of application No. 12/602,053, filed on Jan. 5, 2011, now abandoned.
(60) Provisional application No. 62/186,045, filed on Jun. 29, 2015.
(60) Provisional application No. 60/940,169, filed on May 25, 2007.

(30) Foreign Application Priority Data
May 27, 2008 (US) PCT/US2008/064871

(51) Int. Cl. B23K 35/02; B23K 35/28; B23K 35/30; B21B 1/16; C22C 21/02; C22C 5/08; C22C 30/02; B23K 35/40; C22C 18/04

(52) U.S. Cl. CPC B23K 35/0227; B23K 35/40; B23K 35/288; B23K 35/3006; C22C 18/04; C22C 21/02; C22C 5/08; C22C 30/02; B21B 1/16

(57) ABSTRACT

A shaped, small diameter brazing preform is disclosed. The preform, with a cross-sectional diameter between 0.04 inches and 0.08 inches, comprises a continuous, uniform, cavity in a center of the preform extending along, a length formed by three distinct and generally planar sides of the preform. An opening to the cavity along at least a portion of the cross section creating a gap comprises a flux positively retained within the cavity by a pressure from the three sides. A process of forming the shaped, small diameter brazing preform comprises a generally flat, and planar sheet metal section. A plurality of rollers, each one having a unique surface profile, forms the sheet metal section such that the sheet metal section is formed into a generally triangular shaped preform. The cavity is stuffed with a flux, which is exposed to an exterior of the cavity along the length of the preform.

### CROSS-REFERENCE TO RELATED APPLICATIONS

This application claims priority to U.S. provisional application No. 62/186,045, filed on Jun. 29, 2015, the entire contents of which are hereby expressly incorporated by reference into this application.

### BACKGROUND OF THE INVENTION

### 1. Field of the Invention

The present invention relates generally to the field of brazing. Specifically, a preferred embodiment of the present invention relates to a triangle profile, seam oriented wire for use in brazing applications for coupling metals and a process for making the same.

### 2. Discussion of the Related Art

As is known to those skilled in the art, brazing is a joining process whereby a non-ferrous filler metal or alloy is heated to melting temperature and distributed between two or more close-fitting parts. The molten filler metal and flux interacts, with a thin layer of a base metal and then cools to form, a strong, sealed joint. A wide variety of filler metals and alloys may be used. The filler metal or alloy used to join the base metals has a liquidus point (i.e., the temperature at which the metal melts to become a liquid) substantially below that of the solidus of base metals to be joined so as to ensure that the base metals are not melted during brazing.

Brazing is one of the most versatile methods of joining metals today for several reasons. For one, brazed joints are relatively strong. On nonferrous metals and steels, the tensile strength of a properly made joint will often exceed that of the mewls joined. On stainless steels, it is possible to develop a joint whose tensile strength is 130,000 pounds per square inch. In addition, brazed joints are relatively ductile and thus able to withstand considerable shock and vibration. Also, brazed joints are relatively easy to make and, furthermore, are made rather rapidly% ideally, brazing is used for joining dissimilar metals such as ferrous and non-ferrous metals and metals with widely varying melting points. Further, brazing is performed at relatively low temperatures, thus reducing the risk of warping, overheating, or melting the base metals. Finally, brazing is economical when compared with other joining processes.

Brazing involves the use of capillary action to distribute molten filler metal between the surfaces of the base metals being joined. The brazing process generally involves several distinct steps. First, the operator;must ensure a good fit and proper clearance between the two base metals being joined. Second, the capillary action will only work properly if the metals arc properly cleaned and, as such, the base metals must be properly cleaned prior to joining them together. Next, the parts typically must be fluxed. Flux is a chemical compound applied to joint surfaces before brazing. The flux coating serves to shield the base metal surfaces from the air, thus preventing oxide formation thereon. Then, the metals are held in position in preparation for brazing. Next, the prepared assembly is brazed, which involves heating the assembly to an appropriate brazing temperature, and flowing the filler metal through the joint. Once the joint has been created, it typically must be properly cleaned to remove any flux residue, if corrosive, and to remove any oxide scale formed during the brazing process.

A previously recognized problem has been that oftentimes the liquidus temperature of the Tiller metal or brazing material is too high to be used with some base materials such that use of the brazing material with the base metals will cause the base metals to melt during brazing. Needless to say, it is desirable to provide a brazing material that includes a temperature depressant, whereby the temperature depressant creates a significant temperature window between the liquid state of the brazing material and the solid state (solidus) of the base metal.

Currently, production of, for example, aluminum or silver heat exchanger coils involves using pre-formed rings, referred to herein as “reforms”. A preform is made of a filler alloy that is formed into a shape and applied to the joint for brazing. The preform may also include a flux material coated or cored into the preform. The flux cored into the preform may also escape through an opening, seam, or channel along the length of the preform when heat is applied for the brazing operation. By allowing the flux to escape the core of the preform, the entire, area of the joint may be pre-treated with flux before the filler alloy melts.

In order to produce a strong brazed joint, the surface area contact between the preform and the joint for brazing is desirable to be maximized. The large surface area contact between the preform and the joint, for brazing promotes wicking of the melted flux and the subsequently melted flux into the joint. As the flux has penetrated deeply into the joint as a result of the increased surface area contact, the molten alloy that made up the body of the preform will now also flow deeply into the joint, producing a stronger joint.

What is therefore needed is a preform manufactured to correspond to the surface area of the work piece in order to maximize the surface area contact. What is also needed is a brazing product that when provided in ring form, releases molten and active flux into the joint area prior to the brazing alloy melting. What is also needed is a preform containing flux that allows the molten flux to flash onto the base metal surface to properly limit oxide formation and remove oxides present. What is further needed is an alloy containing silver (Ag) that when it begins to melt will flow uniformly into the braze joint forming a sound bond. An aluminum (Al)-containing alloy for other brazing applications is also needed.

What is also needed is a brazing material for use in applications requiring a window of temperature between the solidus point of the base metals and the liquidus temperature of the brazing material. In addition, what is needed is a brazing material that could take different forms including a strip, wire, flux coated or flux cored product, rings, or other such preforms. Furthermore, what is needed is a brazing material that is capable of having a liquidus point range of 600° F. and 1100° F. for use with aluminum-based preforms and a liquidus point range of 1300° F. and 1900° F. for use with silver-based preforms. Heretofore, these requirements have not been fully met without incurring various disadvantages.

### SUMMARY AND OBJECTS OF THE INVENTION

By way of summary, the present invention is directed to a shaped, small diameter brazing preform preferably comprised of a cross-sectional diameter of 0.04 inches and as large as 0.08 inches for use in brazing processes. It is also contemplated that, the cross-sectional diameter may be less than 0.04 inches. An effect of the present invention is to provide a brazing material for use in applications requiring a small preform to join the base metals of the brazing material contemplated herein. Examples of application include the joining of piping and tubing for heat exchangers and compressors used in final products such as, but not limited to refrigerators, air conditioners, radiators, furnaces, automobile radiators, and the like.

One object of the invention is to provide a continuous, uniform, cavity in a center of the preform extending along a length of the preform. Another object of the invention is to provide a first edge and a second edge extending along the length of the preform wherein at least a portion of the first edge and the second edge do not contact each other forming an opening extending along the length of the preform. A flux within the cavity of a composition different than a composition of the preform is positively retained within the cavity by a pressure from the first and second edge.

Another object of the present invention is to provide a shaped, small diameter brazing preform formed by three planar sides. A first generally planar side may be along a cross-sectional portion of the preform on a perimeter of the cross section. A second generally planar side may be along the perimeter of the cross section in contact with the first generally planar side. A third generally planar side may be along the perimeter of the cross section in contact with the second generally planar side, wherein the opening separates the first generally planar side from the second generally planar side thus forming a generally triangular cross-section.

In accordance with a first aspect of the invention, these objects are achieved by providing a process of forming a shaped, small diameter brazing preform. The first step is to provide a generally flat and planar sheet metal section with a top surface and a bottom surface. The second step is to apply a first roller with a convex surface profile to the top surface of the sheet metal section at a first location. The next step is to apply a second roller with a concave surface profile to the bottom surface of the sheet metal section at a second location directly opposite the first location. Next is to pinch the sheet metal section between the first roller and the second roller with a pressure. Next, form the sheet metal section to conform to the surface profile of the first roller and the second roller. Then, continue to form the sheet metal section with a plurality of rollers, each one having a unique surface profile, such that the sheet metal section is formed into a generally triangular shaped preform with a continuous, uniform, cavity in the center extending along a length of the preform and two edges extending along the length of the preform, wherein a portion of the edges do not contact each other forming an opening extending along the length of the preform. A flux is encapsulated within the cavity such that the flux is exposed to an exterior of the cavity along the length of the preform.

Yet another object of the present invention is to provide a shaped, small diameter brazing preform comprising a preform with three distinct and generally planar sides along a cross-sectional portion of the preform. The length of the preform comprises a generally triangular cross section defined by the planar sizes when the cross section is taken and a continuous, uniform, cavity in a center of the cross section. An opening to the cavity along at least a portion of the cross section creates a gap, comprising a flux positively retained within the cavity by a pressure from the three sides. A diameter of the cross section may be less than 0.08 inches.

Another object of the present invention is to provide a shaped, small diameter brazing preform having a preform with three distinct and generally planar sides along a cross-sectional portion of the preform, a generally triangular cross-section defined by the planar sides when the cross section is taken from any point along the length of the preform, a continuous, uniform, cavity in a center of the cross section and extending along a length of the preform, an opening to the cavity along at least a portion of the cross section creating a gap, wherein the opening extends uniformly along the length of the preform, and a flux positively retained within the cavity by a pressure from the three sides.

These, and other aspects and objects of the present invention, will be better appreciated and understood when, considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

A clear conception of the advantages and features constituting the present invention, and of the construction and operation of typical embodiments of the present invention, will become more readily apparent by referring to the exemplary, and, therefore, non-limiting, embodiments illustrated in the drawings accompanying and forming a part of this specification, wherein like reference numerals designate the same elements in the several views, and in which:

FIG. 1 illustrates a side view of one embodiment of the shaped, small cross-sectional diameter brazing preform of the present invention;

FIG. 2 illustrates a cross-sectional view of the shaped, small diameter brazing preform of FIG. 1 coupled around the surface area of two metal pipes to be brazed;

FIG. 3 illustrates a cross-sectional view of a joint that was brazed using the preform of the present invention compared to a cross-sectional view of a joint that was brazed using the prior art;

FIG. 4 illustrates perspective views of various alternative embodiments of the shaped, small cross-sectional diameter brazing preform of the present invention able to be formed into a limitless number of shapes;

FIG. 5 illustrates a perspective view of another embodiment of the shaped, small cross-sectional diameter brazing preform of the present invention able to be formed into a coil;

FIG. 6 illustrates an end view of another embodiment of the shaped, small cross-sectional diameter brazing preform of the present invention with a small cross sectional diameter (right) and a larger cross sectional diameter (left) of the preform;

FIG. 7 illustrates a close-up end view of the shaped, small cross sectional diameter brazing preform of FIG. 6;

FIG. 8 illustrates a process of forming the shaped, small cross-sectional diameter brazing preform of the present invention. FIG. 8 is for illustration purposes, and the triangular shape may comprise more rounded edges;

FIG. 9 illustrates a schematic drawing of the use of a brazing preform within an end product.

In describing preferred embodiments of the invention, which are illustrated in the drawings, specific terminology will be resorted to for the sake of clarity. However, it is not intended that the invention be limited to the specific terms so selected and it is to be understood that each specific term includes all technical equivalents, which operate in a similar manner to accomplish a similar purpose. For example, the words “connected”, “attached”, “coupled”, or terms similar thereto are often used. They are not limited to direct connection but include connection through other elements where such connection is recognized as being, equivalent by those skilled in the art.

### DETAILED DESCRIPTION OF THE DRAWINGS

### 1. Resume of the Invention

The small cross-sectional triangular preform is formed with a controlled seam along its inner diameter. The seam is controlled such that it is straight and does not wander along the body of the preform. The preform is formed from a small cross sectional wire that has the ability to be formed into rings with an inner diameter of less than 0.25 inches. Creating a preform, or ring, this small is possible by designing a cross section of the ring with a moment of inertia that is closer to the inner diameter of the ring than is typical with a perfectly round ring. In other words, the wire used to form a ring does not have a perfectly circular cross section, but is a flattened circle, or oval. In general, the flatter the side with the seam is, the less prone that side is to warping and buckling when the wire is bent into the preform shape. For example, when the wire has a triangular shaped cross section, the wire remains uniform and the seam does not further open during the bending of the ring forming process.

### 2. Detailed Description of the Preferred Embodiments

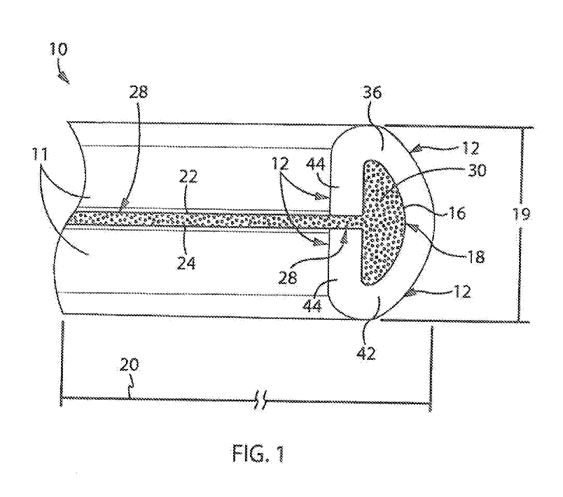

Referring now to the drawings. FIG. 1 shows a configuration of the shaped, small cross sectional diameter brazing preform 10. In this embodiment, flux 30 of a different composition of the preform 10 is surrounded by three walls 12 of the preform 10. The flux 30 is positively retained within the cavity 16 by a pressure from the first edge 22 and second edge 24. The preform 10 is shaped to have a generally triangular cross-section defined, by a first generally planar side 36, a second generally planar side 42, and a third generally planar side 44. The third generally planar side 44 includes the opening 28. A continuous, uniform cavity 16 extends along the length 20 of the preform 10. In this regard, the flux 30 is preferably contained within a center 18 of the preform 10.

In a preferred embodiment of the invention, the flux 30 is 14% by weight of the brazing preform 10. However, in other embodiments of the invention, the flux may be 8-30% by weight of the brazing preform 10.

In one embodiment, the preform 10 may be made into a ring with the opening 28 between the first edge 22 and second edge 24 of the preform 10 facing toward the inner diameter 11 of the ring-shaped preform 10. This construction allows the flux 30 to be retained in the preform 10 without the use of a binder as the first edge 22 and the second edge 24 pinch the flux 30 within the cavity 16. As known in the art, binders do not burn cleanly and often leave residues on and within the braze joint that may impede proper alloy and flux flow resulting in poor braze joint, quality.

In another embodiment, the opening or channel 28 could be on the outside of the ring. In fact, given the inventive method, placement of the opening 28 can be more precisely controlled and therefore can be placed around the inner and outer surface of the ring, in any preferred location.

Table 1 below shows a few exemplary embodiments for the invention when the preform 10 is formed with an aluminum-based filler material.

Nominal

| | Solidus | | Liquidus | | Composition, % | | |
|---|---|---|---|---|---|---|---|
| Product | ° F. | ° C. | ° F. | ° C. | Al | Si | Zn |
| Flux cored | 1070 | 576 | 1080 | 582 | 88 | 12 | |
| Brazing alloy for furnace, | | | | | | | |
| dip and torch brazing of | | | | | | | |
| Al base metals. Alloy is | | | | | | | |
| cored with a non-corrosive | | | | | | | |
| flux. | | | | | | | |
| Flux cored | 710 | 377 | 725 | 385 | 2 | | 98 |
| Solder for joining | | | | | | | |
| aluminum and aluminum | | | | | | | |
| alloy. Alloy is cored with | | | | | | | |
| a non-corrosive flux. | | | | | | | |
| Flux cored | 800 | 426 | 900 | 482 | 22 | | 78 |
| High strength, low | | | | | | | |
| temperature braze for | | | | | | | |
| joining aluminum to | | | | | | | |
| aluminum and aluminum | | | | | | | |
| to copper. | | | | | | | |
| Easy to use, contains a | | | | | | | |
| non-corrosive flux. | | | | | | | |

Table 2 below shows additional exemplary embodiment for the invention when the preform 10 is formed with a silver-based filler material.

Nominal

| | Solidus | | Liquidus | | Composition, % | | | | |
|---|---|---|---|---|---|---|---|---|---|
| Product | ° F. | ° C. | ° F. | ° C. | Ag | Cu | Sn | Zn | Other |
| General purpose | 1250 | 675 | 1410 | 765 | 30 | 38 | | 32 | |
| filler metal for joining | | | | | | | | | |
| ferrous and non- | | | | | | | | | |
| ferrous metals. | | | | | | | | | |
| Sluggish flow, enables | | | | | | | | | |
| filling large gaps. | | | | | | | | | |
| A free flowing filler | 1200 | 648 | 1330 | 720 | 38 | 32 | 2 | 28 | |
| metal used with | | | | | | | | | |
| ferrous and non- | | | | | | | | | |
| ferrous base metals. | | | | | | | | | |
| Excellent general | 1220 | 659 | 1305 | 707 | 50 | 20 | | 28 | 2 Ni |
| purpose alloy. Joins | | | | | | | | | |
| Ni and Fe based | | | | | | | | | |
| alloys, and stainless | | | | | | | | | |
| steel. | | | | | | | | | |
| Lowest temperature, | 1145 | 618 | 1205 | 651 | 56 | 22 | 5 | 17 | |
| Cd-free, silver | | | | | | | | | |
| brazing filler metal. | | | | | | | | | |
| Very fluid alloy joins | | | | | | | | | |
| ferrous and non- | | | | | | | | | |
| ferrous metals. | | | | | | | | | |

In addition to those listed in Table 1, various ranges for the final composition of the shaped, small cross-sectional diameter brazing preform 10 or mixture (“mixture” is defined as, the resulting alloyed braze material in liquid or solid form) are contemplated, and representative compositions are listed below. The following compositions are displayed by weight %:

Ag: 30%+/−10%

Cu: 35%+/−10%

Zn: 30%+/−10%

Other elements: 5%+/−5%

With one preferred embodiment being:

Ag: about 30%

Cu: about 38%

Zn: about 32%

Other elements: <0.5%; and

Another preferred embodiment being:

Ag: about 25%

Cu: about 40%

Zn: about 35%

Other elements: <0.5%; and

Another preferred embodiment being:

Ag: about 38%

Cu: about 32%

Zn: about 28%

Sn: about 2%

Other elements: <0.5%.

The above-disclosed compositions are not meant to be limiting, and as such, other compositions may be used. Although aluminum and silver alloys are preferred, as stated previously, other materials may be used.

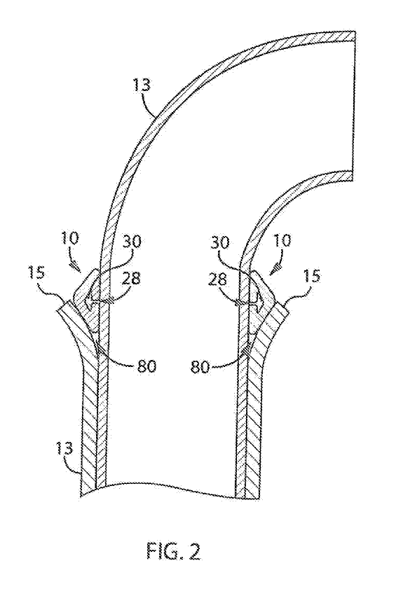

FIG. 2 illustrates one application of the shaped, small diameter brazing preform 10 shown in FIG. 1. In this representative application, the shaped, small cross-sectional diameter brazing preform 10 should be flush against the pipes 13 that are to be brazed together. The triangular cross section of the preform 10 increases the surface area contact such that little to no voids 80 exist in between the two pipes 13 being brazed. The present invention helps ensure production of a sound braze joint more efficiently than conventional brazing materials.

Conventional brazing materials suited for brazing a joint will often have a rectangular, oval, or round cross-sectional geometry in ring form that is then attached to the bent pipe of the heat exchanger. A conventional brazing material in the form of a ring having a rectangular cross-sectional geometry poses a significant disadvantage for brazing because as the assemblies are heated the braze ring is exposed to direct heat and the alloy and flux 30 will often melt and flow away from the joint interface leaving lack of alloy fill and voids. Additionally, it is not uncommon for the ring to completely fall off of the pipe and hairpin during heating due to limited contact between the pipe and hairpin leaving no alloy and flux present to produce.

As also shown in FIG. 2, the, shaped, small cross-sectional diameter brazing preform 10 shown in FIG. 1, is believed to eliminate this disadvantage because the geometry and manufacture of the wire ring allows the braze material to seat more effectively in between the pipe 13 and the hairpin 15. One skilled in the art will appreciate that the invention provides intimate contact between the shaped, small cross-sectional diameter brazing preform 10, hairpin 15, and pipe 13 thereby allowing proper brazing to take place on a consistent basis. The increased surface area of contact between the preform 10, hairpin 15, and pipe also increases the wicking action which draws the flux into the joint first, and subsequently the melted allow of the preform 10.

The flux 30 is formulated to melt prior to the melting of the alloy that forms the preform 10. The molten flux 30 flows out of the channel 28 as shown in FIG. 1 to pre-treat the joint. The intimate contact of the preform 10, hairpin 15, and pipe 13 not only allows the flux and alloy and to flow into the void 80 consistently, but it also limits direct heat on to the braze ring limiting premature melting of the alloy and flux. Additionally, the hairpin 15 provides a mechanical resistance to the shaped, small cross-sectional diameter brazing preform 10 thereby not allowing the preform 10 to move outside of the joint area.

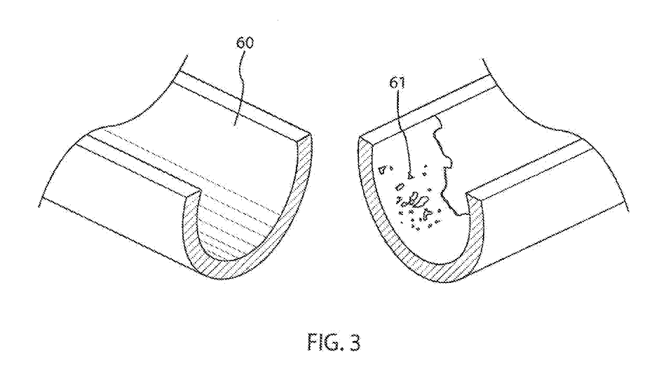

For example, FIG. 3 shows a cross sectional-cut joint that was brazed using the inventive preform 10 compared to a cross-sectional cut of a joint using the prior art. The preform 10 produces braze joint 60 which is clean and sound. The brazed joint 61 shows the prior art with contains voids and is irregularly shaped. The brazed joint 60 using the inventive preform 10 is also deeper into the joint.

Additionally, the geometry and manufacture of the invention allows exposure of the flux 30 to the joint interface without the need to use a binder, which, as described above, can lead to weak joints. As such, being free of binder, the alloy and flux can flow cleanly and freely into the joint interface to create a sound braze.

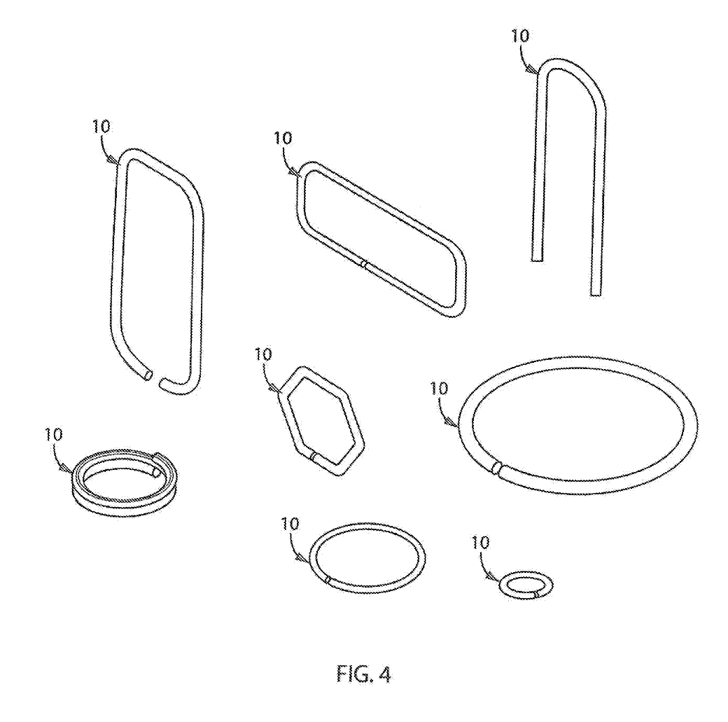

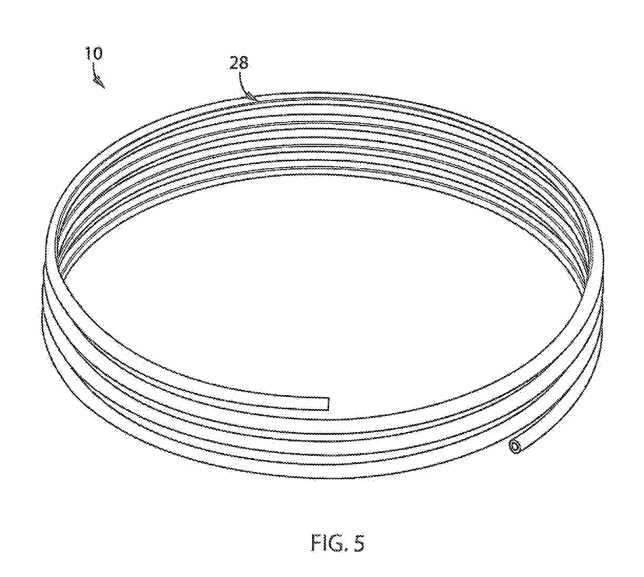

FIGS. 4 and 5 show various preformed, quasi-circular shapes made from the shaped, small diameter brazing preform 10 of FIG. 1. In further embodiments of the invention, the preform 12 is formed into a wire, strip, ring or preformed shapes. Flux 30 coated brazing material of continuous length may be formed into various form factors including wire, loose coils, spools, rings, flat wire and strip.

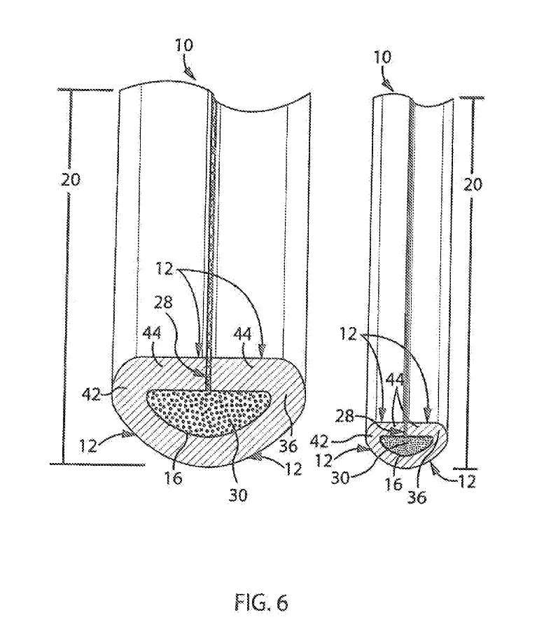

FIG. 6 shows the shaped, small diameter brazing preform 10 (right) next to another exemplary embodiment of the invention with a large cross-sectional diameter.

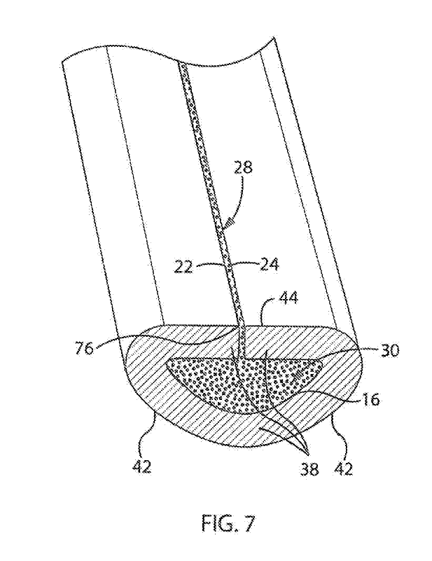

Referring now to FIGS. 6 and 7, the small cross-sectional diameter brazing preform 10 of the present invention is shown. Specifically, FIGS. 6 and 7 show an end view of the preform 10. The preform 10 has three distinct and generally planar sides 36, 42, 44 along a cross-sectional portion 38 of the preform 10. As discussed with respect to FIG. 1, the preform 10 comprises an opening 28 to the continuous, uniform cavity 16 along at least a portion of the cross section creating a gap 76, wherein a flux 30 is positively retained within the continuous, uniform cavity 16 by a pressure from the three sides 36, 42, 44. Although the present embodiment discloses the use of a silver or aluminum alloy, it is understood that, alternatively, other materials may be used including temperature depressing materials.

As mentioned, the present invention may take many forms. However, in, one preferred embodiment, the preform 10 preferably has a cross-sectional diameter 19 of 0.038 inches, see for example FIG. 1. While the aforementioned measurements represent the preferred measurements for the brazing material, it is understood that alternative thicknesses and diameters are contemplated and within the scope of the present invention.

The flux 30 may be in a powder form that is preferably encapsulated in the preform 10. As long as a flux has an active temperature below that of the liquidus of the resulting alloy that forms the preform 10, the flux 30 may be used to practice the present invention. The key again being that the brazing metals of the present invention melt after the flux 30 has already become active rather than before.

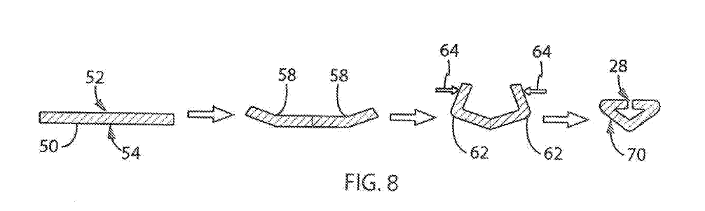

Referring now to FIG. 8, a preferred process of forming a shaped, small cross-sectional diameter brazing preform 10 is shown. The process of forming a shaped, small diameter brazing preform 10 includes the step of first providing a generally flat and planar sheet metal section 50 with a top surface 52 and a bottom surface 54. Next, the process of forming a shaped small diameter brazing preform 10 includes the step of applying a first roller with a convex surface profile to the top surface 52 of the sheet metal section 50 at a first location 58. The first location 58 is shaped such that the flat sheet metal section 50 receives curved edges. The next step in the process of forming a shaped, small diameter brazing preform 10 includes gradually forming the bottom surface 54 of the sheet metal section 50 at a second location 62. The next step includes pinching the sheet metal section 50 with a pressure 64 shown as force-vector arrows in FIG. 8. The sheet metal section 50 is thereby gradually formed into a generally triangular shaped preform 70 with a continuous, uniform cavity 16 in a center of the preform 18 extending along a length of the preform 12 and, a first edge 22 and a second edge 24 extending along the length of the preform 20, wherein at least a portion of the first edge end the second edge 26 do not contact each other forming an opening 28 extending along the length of the preform 20. The in lye process also prevents the opening 28 from “wandering” and ensures it is uniformly straight down the length of the formed preform 70. The inventive process produces a continuous length wire which subsequently may be formed into any shape, as disclosed with respect to FIG. 4.

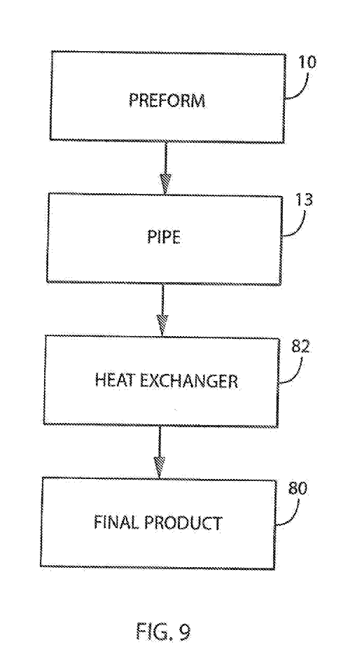

FIG. 9 is a schematic representation of the preform 70 as it is used in a final product 80. As described above, the preform 70 is used to braze the pipe 13. The preform 10 effectively sits in the hairpin 15 of the pipe 13 in order to properly braze the pipe 13 and join the base metals of the pipe 13 on a consistent basis. The pipe 13 is used in a heat exchanger or compressor 82. Finally, the heat exchanger or compressor 82 is used in a final product 80. The final product 80 may be, but is not limited to, a refrigerator, an air conditioner, a radiator, a furnace, an automobile radiator, and the like.

In an alternative embodiment of the invention., the first edge 22 may overlap the second edge 24 to create an overlap seam. Between the first edge 22 and the second edge 22 there may be a gap, in which a portion of the flux resides, resulting in the second edge 22 being surrounded by flux on three sides. As the flux melts, the gap slightly opens and allows the flux to flow out the seam.

There are virtually innumerable uses for the present invention, all of which need not be detailed here. Additionally, all the disclosed embodiments can be practiced without undue experimentation. Further, although the best mode contemplated by the inventors of carrying out the present invention is disclosed above, practice of the present invention is not limited thereto. It will be manifest that various additions, modifications, and rearrangements of the features of the present invention may be, made without deviating from the spirit and scope of the underlying inventive concept.

In addition, the individual components of the present invention discussed herein need not be fabricated from the disclosed materials, but could be fabricated from virtually any suitable materials. One example is the flux. Any oxide prevention substance may be used instead of flux. Moreover, the individual components need not be formed in the disclosed shapes, or assembled in the disclosed configuration, but could be provided in virtually any shape, and assembled it virtually any configuration. Furthermore, all the disclosed features of each disclosed embodiment can be combined with, or substituted for, the disclosed features of every other disclosed embodiment except where such features are mutually exclusive.

It is intended that the appended claims cover all such additions, modifications, and rearrangements. Expedient embodiments of the present invention are differentiated by the appended claims.

What is claimed is:

1. A shaped, small diameter bra-zing preform comprising:
a continuous, uniform, cavity in a center of the preform extending along, a length of the preform;
a first edge and a second edge extending along the length of the preform wherein at least a portion of the first edge and the second edge do not contact each other forming an opening extending along the length of the preform, wherein the opening is uniform along the length of the preform;
a flux within the cavity, the flux having a composition different than a composition of the preform;
a first generally planar side along a cross-sectional portion or the preform on a perimeter of the cross section
a second generally planar side along the perimeter of the cross section in contact with the first generally planar side; and
a third generally planar side along the perimeter of the cross section in contact with the second generally planar side, wherein the opening separates the first generally planar side from the second generally planar side thus forming a generally triangular cross-section.

2. The preform of claim 1 wherein the flux is positively retained within the cavity by a pressure from the first and second edge.

3. The preform of claim 1 wherein a cross-sectional diameter of the preform is between 0.04 inches and 0.08 inches.

4. The preform of claim 1 wherein the composition of the flux has an active temperature below the liquidus temperature of the composition of the preform.

5. The preform of claim 1 wherein the preform is in the form of a preformed shape with the opening facing toward an inner surface of the performed shape.

6. The preform of claim 5 wherein the preformed shape is at least one of a strip, ring, and quasi-circular shape.

7. The preform of claim 1 wherein the preform composition is one of aluminum, silver, aluminum alloy, and silver alloy.

8. A method of forming a shaped, small diameter brazing preform comprising the steps of:
providing a generally flat and planar sheet metal section with a top surface and a bottom surface;
applying a first roller with a convex surface profile to the top surface of the sheet metal section at a first location;
applying a second roller with a concave surface profile to the bottom surface of the sheet metal section at a second location directly opposite the first location;
pinching the sheet metal section between the first roller and the second roller with a pressure to form a generally triangular shaped perform having a uniform cavity in a center of the preform extending along a length of the preform, wherein the uniform cavity is exposed via a uniform opening extending along the length of the preform; and
encapsulating a flux within the cavity.

9. The method of claim 8 wherein applying a first roller with a convex surface profile to the top surface of the sheet metal section comprises thrilling the sheet metal section to conform to the surface profile of the first roller.

10. The method of claim 9 wherein applying a second roller with a concave surface profile to the bottom surface of the sheet metal section at a second location directly opposite the first location comprises forming the sheet metal section to conform to the surface profile of the second roller.

11. The method of claim 9 wherein the generally triangular shape comprises a first generally planar side, a second generally planar side, and a third generally planar side; and
wherein the third generally planar side comprises a first edge and a second edge along the length of the preform that do not contact each other to form the opening, such that the flux is exposed to an exterior of the cavity along the length of the preform.

12. The method of claim 11 wherein the flux is positively retained within the cavity by a pressure from the first, second, and third generally planar sides.

13. The method of claim 9 further comprising shaping the preform into at least one of a wire, strip, ring, and quasi-circular shape.

14. A shaped, small diameter brazing preform comprising:
a preform with three distinct and generally planar sides along a cross-sectional portion of the preform;
a generally triangular cross-section defined by the planar sides when the cross section is taken from any point along the length of the preform;
a continuous, uniform, cavity in a center of the cross section and extending along a length of the preform;
an opening to the cavity along at least a portion of the cross section creating gap, wherein the opening extends uniformly along the length of the preform; and
a flux positively retained within the cavity by a pressure from the three sides.

15. The preform of claim 14 wherein a diameter of the cross-section is less than 0.08 inches.

16. The preform of claim 14 the opening is disposed between a first edge and a second edge of one of the three sides, wherein the first edge and the second edge do not contact each other along the length of the preform.

17. The preform of claim 14 wherein the preform melts at a first temperature and the flux melts at a second temperature, the second temperature lower than the first temperature.

18. The preform of claim 14 wherein the preform is in the form of a preformed shape with the opening facing toward an inner surface of the performed shape, the preformed shape being at least one of a wire, strip, ring, and quasi-circular shape.

19. The preform of claim 14 wherein the preform composition is one of aluminum, silver, aluminum alloy, and silver alloy.

20. The preform of claim 14 wherein the brazing preform is used to braze a pipe of a heat exchanger, the heat exchanger being used within a final product o at least one of a refrigerator, an air conditioner, a radiator, a furnace, an automobile radiator.
